(19) United States
(12) Patent Application Publication
(10) Pub. No.: US 2015/0006002 A1
(43) Pub. Date: Jan. 1, 2015

(54) TRANSPORTATION MANAGEMENT SYSTEM FOR BATTERY POWERED VEHICLES

(71) Applicant: KABUSHIKI KAISHA TOSHIBA, Tokyo (JP)

(72) Inventor: Fumiyuki YAMANE, Kawasaki (JP)

(73) Assignee: KABUSHIKI KAISHA TOSHIBA, Tokyo (JP)

(21) Appl. No.: 14/247,106

(22) Filed: Apr. 7, 2014

(30) Foreign Application Priority Data
Jun. 28, 2013 (JP) 2013-137275

(51) Int. Cl. G01C 21/00

(52) U.S. Cl. CPC G01C 21/00
USPC 701/22

(57) ABSTRACT

A method for managing a transportation service along a plurality of routes with a plurality of vehicles, includes allocating a vehicle to a first route, calculating an amount of power to be used by the vehicle while the vehicle is providing transportation service along the first route, determining a range of power to be stored in a battery of the vehicle based on at least a deterioration degree of the battery, and reallocating the vehicle to a second route based on the calculated amount of power and the determined range of power to be stored in the battery of the vehicle.

### CROSS-REFERENCE TO RELATED APPLICATION

This application is based upon and claims the benefit of priority from Japanese Patent Application No. 2013-137275 filed on Jun. 28, 2013, the entire contents of which are incorporated herein by reference.

### FIELD

The present invention relates to a transportation management system for battery powered vehicles.

### BACKGROUND

Conventionally, there is a method by which plural battery-powered vehicles are assigned to service routes of a transportation system in accordance with a predetermined service schedule. However, in the assignment of the vehicles according to such a method, the amount of deterioration of the battery is not considered.

### BRIEF DESCRIPTION OF THE DRAWINGS

FIG. 1 schematically illustrates a configuration of a system including the managing system according to an embodiment.

FIG. 2 schematically illustrates a configuration of the managing system according to the embodiment.

FIG. 3 is a flowchart illustrating an example of a calculation process by a first calculation part of the managing system according to the embodiment.

FIG. 4 is a flowchart illustrating an example of a calculation process by a second calculation part of the managing system according to the embodiment.

FIG. 5 is a flowchart illustrating an example of a calculation process by a third calculation part of the managing system according to the embodiment.

FIG. 6 is a flowchart illustrating an example of a calculation process by a setting part of the managing system according to the embodiment.

FIG. 7 is a flowchart illustrating an example of a calculation process by an update part of the managing system according to the embodiment.

FIG. 8 is a flowchart illustrating an example of a calculation process by an assignment part of the managing system according to the embodiment.

### DETAILED DESCRIPTION OF THE EMBODIMENTS

According to one embodiment, a method for managing a transportation service along a plurality of routes with a plurality of vehicles, includes allocating a vehicle to a first route, calculating an amount of power to be used by the vehicle while the vehicle is providing transportation service along the first route, determining a range of power to be stored in a battery of the vehicle based on at least a deterioration degree of the battery, and reallocating the vehicle to a second route based on the calculated amount of power and the determined range of power to be stored in the battery of the vehicle.

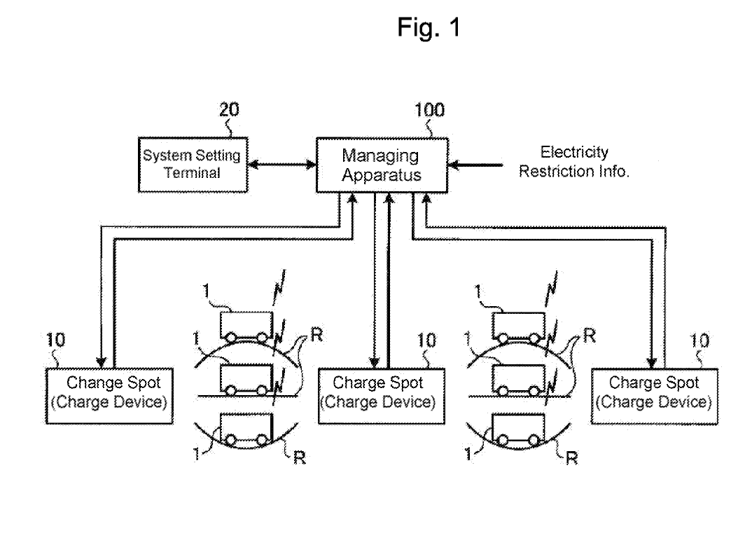

In one embodiment, a vehicle 1 is an electric vehicle (battery-powered vehicle) provided with a battery that can be repeatedly charged (a secondary battery is not illustrated) and a vehicle drive device such as a motor powered using the electricity stored in the battery. The vehicle 1 is, for example, a bus (a route bus), a vehicle of light rail transit (LRT), or the like. As illustrated in FIG. 1, each route R of the vehicle 1 is set so as to connect charge spots 10 (charge station, charge terminal, or charge device). For example, a route R can be set as a route connecting two different charge spots 10, or it can be set as a route that begins from one charge spot 10 and returns to the same charge spot 10. Each of the charge spots 10 is equipped with at least one charge device (charger not illustrated). Each of the charge spots 10 can be in a terminal of the vehicle 1, a stop, a station, an office, a garage, and the like. In such a transportation system of the embodiment, the route R is a unit (section) to which at least one vehicle 1 is assigned.

In the present embodiment, a service schedule (time schedule, timetable, or diagram) of the vehicles 1 on a plurality of routes R is determined beforehand. A managing system 100 (a managing system for managing a transportation service of the battery-powered vehicle) is configured by at least one computer. The managing system 100 assigns at least one of the vehicles 1 to each route R (makes plans) before the vehicle 1 runs along the assigned route R so that the vehicle 1 runs along the assigned route R in accordance with the service schedule. When the electricity stored in the battery of the vehicle 1 runs out, the vehicle 1 cannot run. Therefore, when assigning the vehicle 1 to each routes R, the managing system 100 conducts the calculation process based on an efficiency of each vehicle, a characteristic of the route R, and the efficiency, the condition, and the like of the battery so that the vehicle 1 can complete the service along the assigned route R without its battery running out of electricity. Also, the managing system 100 can change the assignment (plan) that was once determined according to conditions. For example, when a traffic congestion, an accident, or a trouble of the vehicle occur and the service is not likely to be completed as planned, the managing system 100 can change the existing plan. For example, the managing system 100 changes the vehicle assigned to the routes R.

Also, the managing system 100 is electronically or communicably connected to the system setting terminal 20 that is configured as a computer. An operator can set and change a program, a parameter, and the like to be used in the managing system 100 by operating the system setting terminal 20.

Also, the managing system 100 assigns each vehicle 1 to each route R based on electricity restriction information corresponding to a demand response and the like. The demand response may be (occasionally) conducted by a local unit (area, local government). When the routes R that the managing system 100 manages extend over a plurality of the demand response areas (divisions) having different demand response, a situation below may happen: for some of the charge spots 10 located within the area where the electricity amount is restricted by the demand response, the electricity amount that can be used to charge is restricted; and for the others of the charge spots 10 located in other areas, the electricity amount that can be used to charge is not restricted. Therefore, the managing system 100 obtains the electricity amount that can be charged at each charge spot 10 and also determines the electricity amount (to charge) to be supplies to the battery of each vehicle 1 at each charge spot 10.

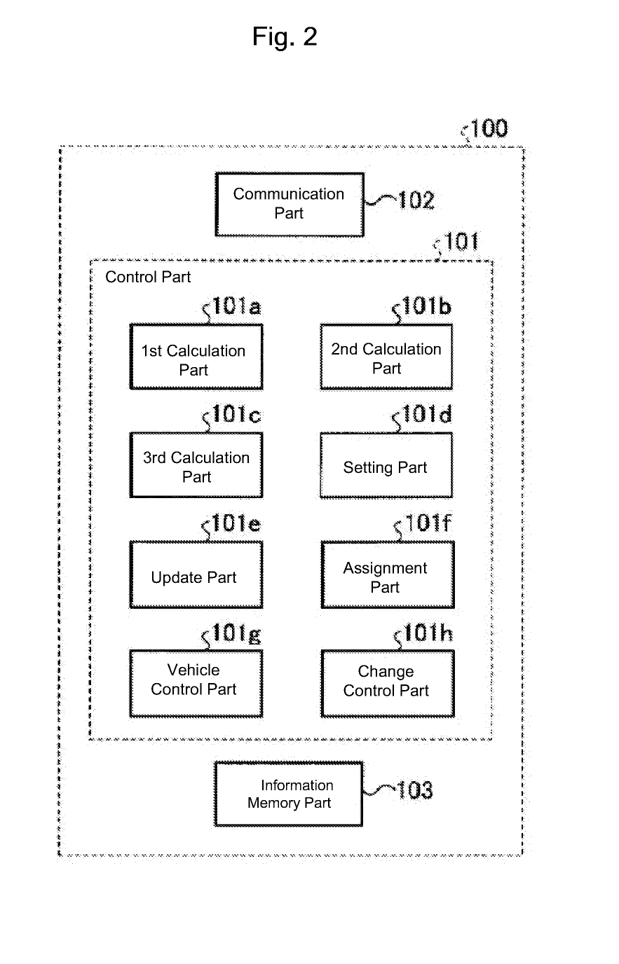

Also, in the embodiment, as an example, the managing system 100 illustrated in FIG. 2 is configured as a computer and including a central processing unit (CPU), a controller, a memory part, an input part, an output part, a communication part 102, and the like. The communication part 102 conducts giving and receiving (communication) of data with the vehicle 1, the charge device of the charge spot 10, and the like. The memory part is, for example, a random access memory (RAM), a read only memory (ROM), a hard disk drive (HDD), a solid state drive (SSD), or the like. The memory part includes an information memory part 103. The information memory part 103 stores various data related to the calculation process performed at the control part 101. The information memory part 103 is a nonvolatile memory part (e.g., a server including HDD, SSD, or the like). The CPU can conduct various calculation processes in accordance with a loaded program (for example, programs related to operating system (OS), application, web application, or the like). In the embodiment, as an example, the control parts 101 illustrated in FIG. 2 (a first calculation part 101a, a second calculation part 101b, a third calculation part 101c, a setting part 101d, an update part 101e, an assignment part 101f, a vehicle control part 101g, a charge control part 101h, and the like) functions according to the CPU or the like executing the program. The control parts 101 conduct various calculation processes to assign the vehicle 1 to each route R. Also, the control parts 101 manage the vehicle 1, the charge spot 10, and the like by giving and receiving data via the communication part 102.

The program executed by the managing system 100 can be recorded in the recording device that can be read by a computer, compact disc ROM (CD-ROM), flexible disc (FD), CD recordable (CD-R), digital versatile disc (DVD), or the like, in a file of an installable or feasible form. Also, the program can be stored in a memory part of a computer connected to a communication network and executed by downloading through the network. The program may be incorporated into the ROM or the like beforehand.

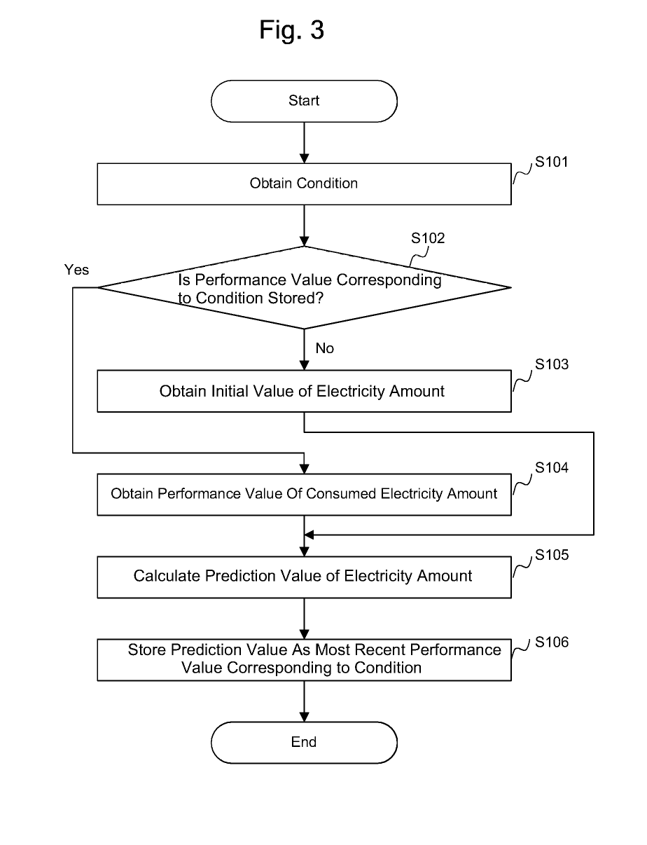

When the assignment part 101f assigns the vehicle 1 to each route R, the first calculation part 101a calculates (estimates) the electricity amount to be consumed by the vehicles 1 assigned to each route R based on a performance value (i.e., an electricity amount related to past service on each condition). Specifically, for example, the first calculation part 101a conducts the process in accordance with the flow of FIG. 3. First, the first calculation part 101a obtains information (numbers, class, flags etc.) indicating the condition (division, occasion, parameter) to calculate the electricity amount to be consumed with respect to the target route R and vehicle 1. At step S101, the first calculation part 101a obtains the information indicating the condition from the information memory part 103, the system setting terminal 20, other devices (for example, a server of a weather forecast and the like), and the like. For example, the information used to calculate the electricity amount to be consumed includes information related to the vehicle 1 (meta information of the vehicle 1, attribute information), information related to the route R (meta information of the route R, attribute information), other information, and the like. For example, the information related to the vehicle 1 includes identification information of the vehicle 1 (identifier, identification number), identification information of the tire used, and the like. Also, the information related to the route R includes identification information of the route R, identification information of the service, and the like. Also, the other information includes whether events are held or not, identification information of the events, identification information at the time of the service (year, month, date, day, season, and the like), weather information, and the like. The performance value or an initial setting value of the electricity amount is stored in the information memory part 103 so as to correspond to the values of each condition (values, amount, character string, rank, order, flag, and the like) described above.

Next, the first calculation part 101a refers to (searches) the information memory part 103. Here, when the performance value corresponding to the condition obtained at step S101 is stored in the information memory part 103 (Yes at step S102), the first calculation part 101a obtains the performance value from the information memory part 103 (step S104). In contrast, when the performance value corresponding to the condition obtained at step S101 is not stored in the information memory part 103 (No at step S102), the first calculation part 101a obtains the initial setting value (initial value) from the information memory part 103 (step S103). The initial setting value corresponding to each condition is stored in the information memory part 103 beforehand. Then, the first calculation part 101a calculates a prediction value of the electricity amount to be consumed corresponding to the condition obtained at step S101 by using the performance value obtained at step S104 or the initial value obtained at step S103 (step S105). At step S105, the prediction value is calculated as an average (moving average) value of the performance values corresponding to the most recent services (predetermined numbers of times, for example, past three times including the most recent time). Hereby, in the information memory part 103, the performance values of a plurality of times with respect to each condition are stored. When the performance values do not exist, the initial setting value itself corresponds to the prediction value. If no initial setting value corresponding to the condition is stored in the information memory part 103, plural initial setting values corresponding to other conditions may be obtained instead. In this case, an average value of the plural initial setting values obtained from the information memory part 103 may be used as the prediction value. Then, the prediction value of the electricity amount calculated at step S105 is used for the assignment process performed by the assignment part 101f. Also, the first calculation part 101a stores in the information memory part 103 the prediction value calculated at step S105 as the most recent performance value corresponding to the condition (step S106). The value calculated at step S105 is the prediction value calculated before the vehicle 1 runs along the route R, but not a value actually consumed by the service. The performance value stored at step S106 is a value of the predictive calculation.

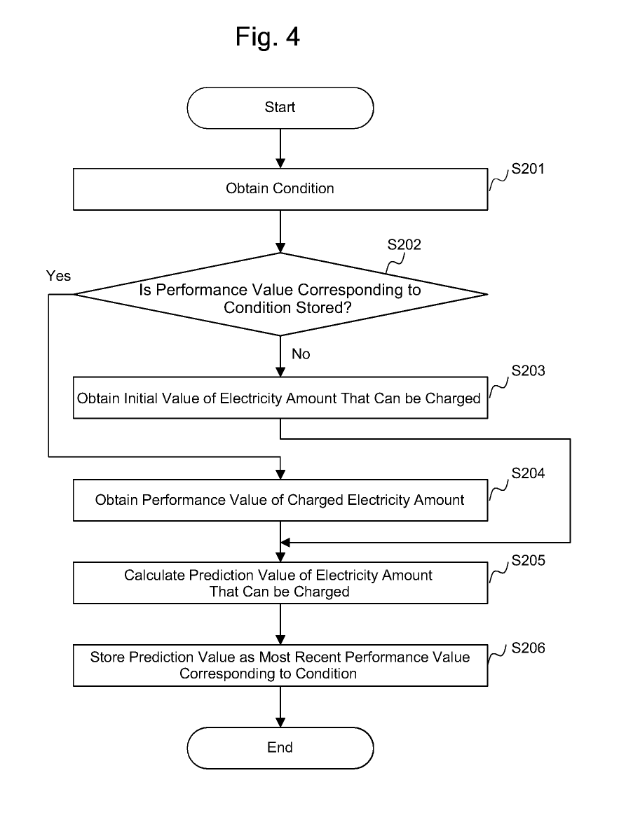

Also, when the assignment part 101f assigns the vehicle 1 to each route R, the second calculation part 101b calculates (predicts) the electricity amount that can be charged at the charge spot 10 (of the charge device) based on the performance value and the like of each condition. Specifically, for example, the second calculation part 101b conducts the process in accordance with the flow of FIG. 4. First, the second calculation part 101b obtains information (values, rank, flag, and the like) indicating a condition (division, occasion, parameter) to calculate the electricity amount that can be charged. In this step S201, the second calculation part 101b obtains the information indicating the condition from the information memory part 103, the system setting terminal 20, other device (for example, the server of weather forecast and the like), and the like. The information used to calculate the electricity amount that can be charged includes electricity restriction information corresponding to the demand response and the like, the information related to the route R, other information, and the like. The second calculation part 101b obtains the electricity restriction information corresponding to the demand response and the like in association with identification information of the charge spot 10 (charge device) or area identification information where the charge spot 10 (charge device) is located. Hereby, the second calculation part 101b can accurately associate the electricity restriction information with the corresponding charge spot 10 (charge device). Also, the information related to the route R and other information are same as the information used to calculate the electricity amount to be consumed. The performance values of the electricity amount that can be charged or the initial setting value are memorized in the information memory part 103 corresponding to the value of each condition.

Next, the second calculation part 101b refers to (searches) the information memory part 103. Here, when the performance value corresponding to the condition obtained at step S201 is stored in the information memory part 103 (Yes at step S202), the second calculation part 101b obtains the performance value from the information memory part 103 (step S204). In contrast, when the performance value corresponding to the condition obtained at step S201 is not stored in the information memory part 103 (No at step S202), the second calculation part 10 lb obtains the initial setting value (initial value) from the information memory part 103 (step S203). The initial setting value corresponding to each condition is stored in the information memory part 103 beforehand. Then, the second calculation part 101b calculates the prediction value of the electricity amount that can be charged corresponding to the condition obtained at step S201 using the performance value obtained at step S204 or the initial value obtained at step S203 (step S205). At step S205, the prediction value is calculated as an average (moving average) value of the performance values corresponding to the most recent services (predetermined number of times, for example, the past three times including the most recent time). Hereby, in the information memory part 103, the performance values of a plurality of times with respect to each condition are stored. When the performance value does not exist, the initial setting value corresponds to the prediction value. If no initial setting values corresponding to the condition is stored in the information memory part 103, plural initial setting values corresponding to other conditions may be obtained instead. In this case, an average value of the plural initial setting values obtained from the information memory part 103 may be used as the prediction value. Also, in order to calculate the prediction value of the electricity amount that can be charged at step S205, the electricity restriction information is used. As an example, an upper limit value of the prediction value of the electricity amount that can be charged at each charge spot 10 (charge device) can be set from the electricity restriction information. In this way, the prediction value of the electricity amount calculated at step S205 is used for the assignment process performed by the assignment part 101f. Also, the second calculation part 101b stores in the information memory part 103 the prediction value calculated at step S205 corresponding to the condition as the most recent performance value (step S206). The value calculated at step S205 is the prediction value calculated before the vehicle 1 runs along the route R, but not a value actually charged before the service. The performance value stored at step S206 is a value of the predictive calculation.

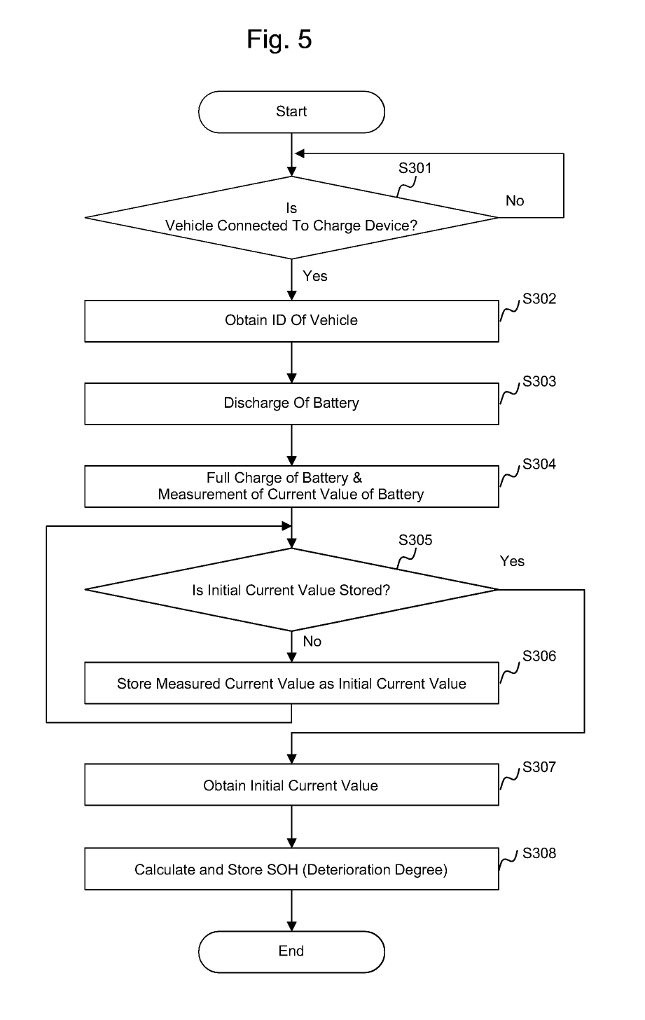

Also, when the assignment part 101f assigns the vehicle 1 to each route R, the third calculation part 101c calculates (obtains) and stores in the information memory part 103 the state of health (SOH or deterioration degree) of the battery (not illustrated) mounted in the each vehicle 1 from the charging state at the charge spot 10 (charge device) of the vehicle 1. Specifically, for example, the third calculation part 101c conducts the process in accordance with the flow of FIG. 5. First, when the vehicle 1 is connected to the charge device (Yes at step S301), the third calculation part 101c obtains the identification information (ID) of the vehicle 1 connected to the charge device (step S302). Next, the third calculation part 101c sends instruction information to the vehicle control part 101g and the charge control part 101h so that the battery of the vehicle 1 is once discharged and then fully charged. The vehicle control part 101g and the charge control part 101h control the vehicle 1 and the charge device based on the instruction information so that the battery of the vehicle 1 is once discharged and then fully charged. That is, the charge device controls the battery of the vehicle 1 to discharge the stored electricity (step S303). Next, the charge device fully charges the battery of the vehicle 1. At that time, the current value that flows from the fully-charged battery of the vehicle 1 is measured. The third calculation part 101c obtains the measured current value (step S304). Here, the third calculation part 101c refers to (searches) the information memory part 103. When the initial current value of the battery is stored in the information memory part 103 (Yes at step S305), the third calculation part 101c obtains the initial current value from the information memory part 103 (step S307). In contrast, when the initial current value of the battery is not stored in the information memory part 103 (No at step S305), the third calculation part 101c stores in the information memory part 103 the measured current value obtained at step S304 as the initial current value of the battery of the vehicle 1 and goes back to step S305 (step S306). Next, the third calculation part 101c calculates the SOH (deterioration degree) with respect to the battery of each vehicle 1 and updates the SOH stored in the information memory part 103 (step S308). SOH (%) can be calculated with, for example, the following formula (1).

(SOH)=((Current Value Gained At Step S304)÷(Initial Current Value Gained At Step S305))×100 (1)

Deterioration degree (%) can be calculated as (100−SOH). The third calculation part 101c can control the information memory part 103 to store SOH and the deterioration degree of each battery mounted in the vehicles 1 and store the SOH and the deterioration degree as the performance value. The process in accordance with the flow of FIG. 5 is conducted by the third calculation part 101c at the proper timing that is set beforehand (for example, predetermined time interval, predetermined mileage interval).

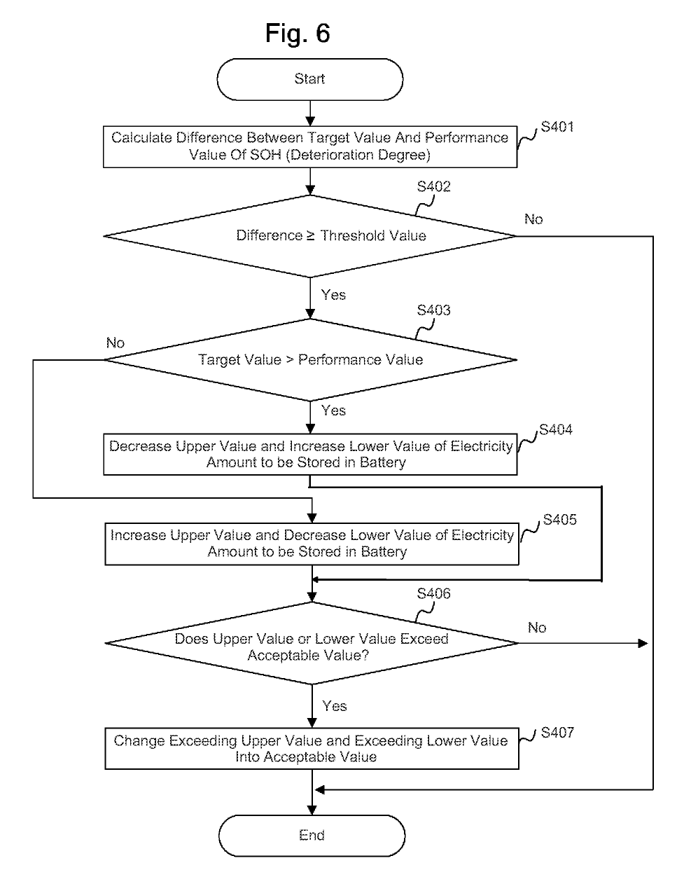

Also, when the assignment part 101f assigns the vehicle 1 to each route R, the setting part 101d sets a range of the electricity amount to be stored in the battery of each vehicle 1 during the service based on the deterioration degree of the battery. Specifically, for example, the setting part 101d conducts the process in accordance with the flow of FIG. 6. First, the setting part 101d calculates a target value of SOH (deterioration degree) and the performance value of SOH (deterioration degree) (step S401). In this step S401, the setting part 101d obtains the target value and the calculated value of SOH from the information memory part 103. The target value is a value that is set in advance according to a running time and/or the running distance for which the battery has been used. The setting part 101d obtains the target value according to the running time and the running distance at the time of the calculation. Also, the performance value is calculated at step S308 of the flow of FIG. 5, and it is the value stored in the information memory part 103. Next, the setting part 101d compares the difference between the target value and the performance value with a threshold value that is set beforehand (step S402). In this step, the threshold, for example, can be set as 5% of the value of the initial capacity. When the difference is larger than the threshold value (Yes at step S402), and, further, when the performance value is lower than the target value (Yes at step S403), the setting part 101d decreases the upper limit value of the electricity amount to be stored in the battery and increase the lower limit value (step S404). In this step S404, the upper limit value and the lower limit value of the electricity amount to be stored (%, as an example, state of charge, SOC) can be calculated with, for example, the following formula (2).

(Upper Limit Value)=(Upper Limit Value Set)−5

(Lower Limit Value)=(Upper Limit Value Set)+5 (2)

With these settings, when the deterioration is advanced (i.e., the performance value of SOC is lower than the target value of SOC), the range of the electricity amount in the battery for use can be narrowed. Therefore, the further deterioration of the battery can be restrained. At step S404, even when the lower limit value is constant and only the upper limit value is decreased, the similar effect can be gained.

In contrast, when the difference is larger than the threshold value (Yes at step S402), and further, when the performance value is higher than the target value (No at step S403), the setting part 101d increases the upper limit value of the electricity amount to be stored in the battery and decreases the lower limit value (step S405). In this step S405, the upper limit value and the lower limit value of the electricity amount to be stored (%, as an example, state of charge, SOC) can be calculated with, for example, the following formula (3).

(Upper Limit Value)=(Upper Limit Value Set)+5

(Lower Limit Value)=(Upper Limit Value)−5 (3)

With these settings, when the deterioration is not advanced, the range of the electricity amount in the battery for use can be expanded. Therefore, the battery can be used more efficiently, and the cruising distance of the vehicle 1 can become longer. At step S405, for example, when the lower limit value is constant and only the upper limit value is increased, the similar effect can be gained. At step S405, when the upper limit value or the lower limit value exceeds each corresponding acceptable value that is set beforehand (Yes at step S406), the upper limit value and the lower limit value are respectively set to be the acceptable value (step S407). Also, the upper limit value and the lower limit value that are set at step S404, S405, and S407 above, that is, the value of the electricity amount to be stored in the battery are stored in the information memory part 103 at any time and updated. In this way, the setting part 101d sets the range of the electricity amount to be stored in the battery of each vehicle 1 based on the deterioration degree of the battery. The process according to the flow of Fig. is conducted by the setting part 101d at the proper timing that is set beforehand (for example, predetermined time interval, predetermined mileage interval).

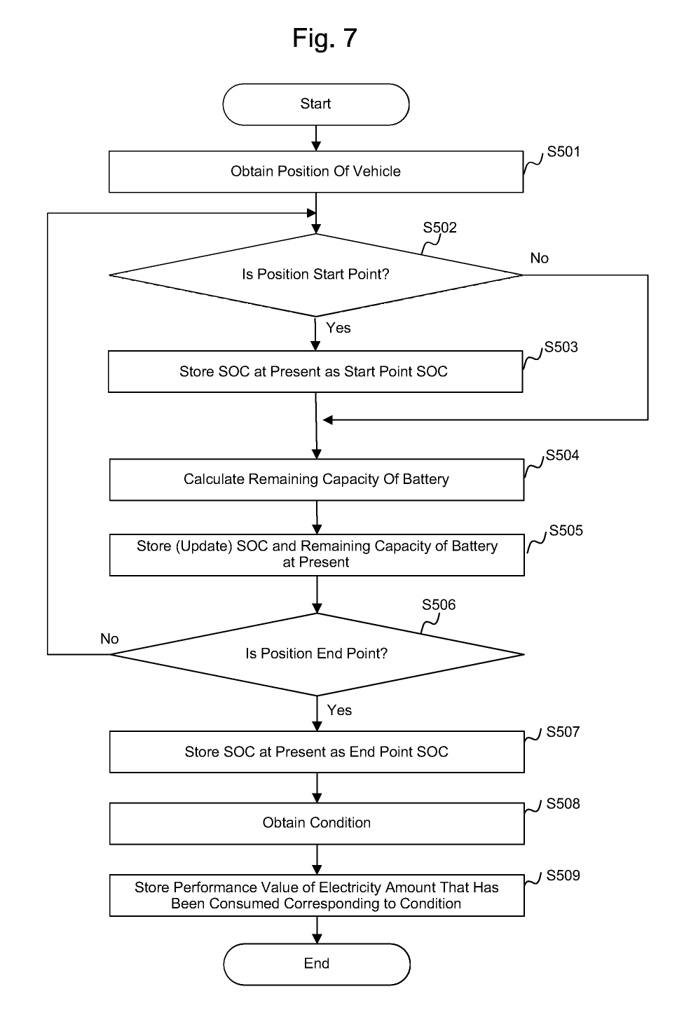

Also, the updated part 101e controls the information memory part 103 to store the electricity amount that has been consumed during the service of each vehicle 1 along each route R as the performance value of electricity corresponding to each condition. Specifically, for example, the updated part 101e conducts the process according to the flow of FIG. 7. First, the update part 101e obtains a position of the vehicle 1 (step S501). Next, when the position of the vehicle 1 is a start point of the route R (Yes at step S502), the update part 101e obtains state of charge (SOC (%)) at present and stores in the information memory part 103 the SOC as a start point SOC (step S503). In contrast, at step S502, when the position of the vehicle 1 is not the start point of the route R (No to step S502), the update part 101e obtains the SOC at present and calculates the remaining capacity of the battery at the present using the SOC at the present with, for example, following formula (4) (step S504).

(Remaining Capacity of Battery)=(Current Value At Management Start Time)×(SOH)×(100−(SOC At Present))×(Battery Voltage)÷1000 (4)

The current value at the management start time is the initial current value of the battery. For example, it is measured when the vehicle is charged for the first time and stored in the information memory part 103 corresponding to the identification information of the vehicle 1 or the battery. Then, the update part 101e updates the SOC at present and the remaining capacity of the battery at present stored in the information memory part 103 (step S505). Next, when the position of the vehicle 1 is the end point of the route R (Yes at step S506), the update part 101e stores the SOC at the present as the SOC at the end point in the information memory part 103 (step S507). When the answer at step S506 is No, the process goes back to step S502. Next, the update part 101e obtains the condition related to the service along the route R by the corresponding vehicle 1, calculates the performance value of the electricity amount that has been actually consumed, and updates the performance value corresponding to the condition obtained at step S508 (step S509) stored in the information memory part 103. In this step S509, the update part 101e calculates (the performance value of) the electricity amount that has been consumed when the vehicle 1 runs along the route R with, for example, following formula (5).

$$( Consumed Electricity Amount ) = ( Current Value At Management Start Time ) \times ( SOH ) \times ( ( SOC At Start Point ) - ( SOC At End Point ) ) \times ( Battery Voltage ) \div 1000 \qquad ( 5 )$$

Hereby, the assignment part 101f can update the electricity amount that has been consumed by the performance value. Therefore, the accuracy of the process performed by the assignment part 101f can be increased.

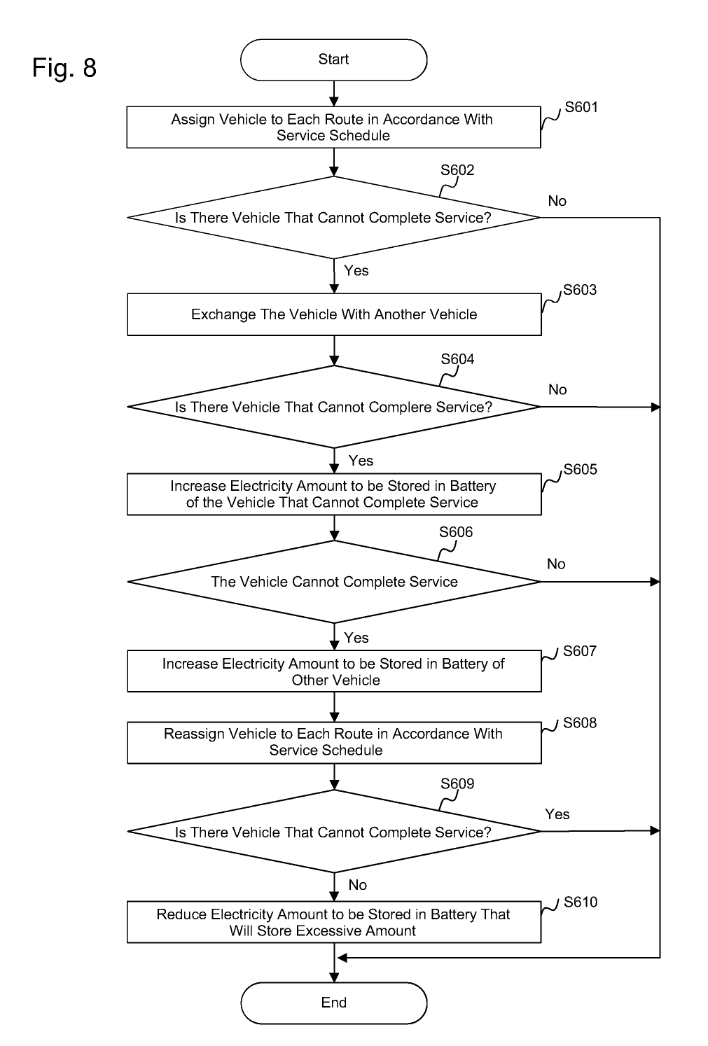

Also, the assignment part 101f conducts the process to assign the vehicle 1 to each route R, for example, in accordance with the flow of FIG. 8. First, the assignment part 101f assigns the vehicle 1 to each route R in accordance with the service schedule (step S601). In this step S601, the assignment part 101f assigns the vehicle 1 to each route R in accordance with the service schedule employing the prediction value of the electricity amount to be consumed , which is calculated in the first calculation part 101a, the prediction value of the electricity amount that can be charged at the charge spot 10 (charge device), which is calculated in the second calculation part 101b, the SOH (deterioration degree) of the battery of each vehicle 1, which is calculated in the third calculation part 101c, the electricity amount to be stored in the battery of each vehicle 1, which is calculated in the setting part 101d, and the performance value of the electricity amount that has been consumed, which is calculated in the update part 101e, so that the electricity amount to be stored in the battery of each vehicle 1 is enough to complete the service along each route R when each vehicle runs along one of the routes R in accordance with the service schedule, that is, the electricity amount to be stored in the battery of the vehicle 1 is equal to or more than the electricity amount to be consumed in the service along the route R by the vehicle 1. In other words, the assignment part 101f assigns the vehicle 1 to each route R so that the service schedule can be followed and the electricity amount to be stored in the battery of the vehicle 1 is not less than the electricity amount to be consumed while the vehicle 1 runs along the route R. Also, the assignment part 101f determines the assignment of the vehicles 1 based on the electricity amount to be charged at the charge spot 10 (charge device) and the time needed to charge into the condition. At step S601, the vehicle 1 is temporarily assigned to each route R. In this step S601, when the vehicle 1 that satisfies the above-described conditions is assigned to every route R, the process of FIG. 8 (assignment) is finished. The assignment part 101f can conducts the calculation process adding or reducing a margin with respect to the prediction value of the electricity amount to be consumed and the prediction value of the electricity amount that can be charged at the charge spot 10 (charge device), and the like. Hereby, it is easier to handle the unexpected situation. Specific margins can be increased or decreased by, for example, multiplying a coefficient. It is possible to make the margin that is added to the prediction value based on the performance value (for example, (adding value or reducing value equivalent to (the predicted value)×0.1) smaller than another margin that is added to the initial value based on the performance value (for example, adding value or reducing value equivalent to (the predicted value)×0.4). By doing this, as an example, it becomes easier for the vehicle 1 to more reliably complete the run of the route R.

In contrast, in the process of step S601, when there is a vehicle 1 that cannot complete the service along the route R, that is, in other words, the vehicle 1 cannot be assigned to every route R (Yes at step S602), the assignment part 101f exchanges the vehicle 1 assigned to a route R with another vehicle 1 assigned to another route R (step S603). When all assigned vehicles 1 can complete the service along the route R (No at step S604), the calculation process of FIG. 8 (assignment) is finished. In contrast, when there is a vehicle 1 that cannot complete the service along the route R even after the process at step S603 is conducted (Yes at step S604), the assignment part 101f increases the electricity amount to be stored in the battery of the vehicle 1 (step S605). In this step S605, for example, the assignment part 101f conducts a process same as the steps S405 to S407 of FIG. 6 with respect to the vehicle 1. In this step S605, when the vehicle 1 can complete the service along the route R (No at step S606), the calculation process of FIG. 8 (assignment) is finished. In contrast, when the vehicle cannot complete the service along the route R (Yes at step S606), the assignment part 101f increases the electricity amount to be stored in the battery of the other vehicle 1 (step S607). In this step S607, the assignment 101f, for example, conducts the process same as the steps S405 to S407 with respect to the other vehicle 1. Next, the assignment part 101f conducts the process to assign the vehicle 1 to each route R in accordance with the service schedule all over again (step S608). By conducting the calculation process of this step S608, when all vehicles 1 can complete the service along the route R, that is, in other words, the vehicle 1 is successfully assigned to every route R (No at step S609), the assignment part 101f reduces the electricity amount to be stored in the battery of the vehicle 1 that will store excessive amount (step S610). In this step S610, for example, the assignment part 101f conducts a process that is same as the step S404 of FIG. 6 within the possible range with respect to at least one vehicle 1. In contrast, when the vehicle 1 that cannot complete the service along the route R exists even after the assignment part 101f conducts the process, that is, the assignment part 101f cannot assign the vehicle 1 to every route R (Yes at step S609), although not illustrated, it may be possible to solve the problem by increasing the electricity amount that can be charged at the charge spot 10 (charge device).

As explained above, in this embodiment, as an example, the setting part 101d sets a range of the electricity amount to be stored in the battery of each vehicle 1 based on the SOH (deterioration degree) of the battery. Therefore, according to the embodiment, as an example, the deterioration of the battery can be restrained.

Also, in the embodiment, as an example, the setting part 101d decreases the upper limit value of the electricity amount to be stored in the battery as the deterioration degree of the battery gets larger. Therefore, according to the embodiment, as an example, the deterioration of the battery can be further more effectively restrained.

Also, in the embodiment, as an example, the setting part 101 d increases the lower limit of the electricity amount to be stored in the battery as the deterioration degree of the battery gets larger. Therefore, according to the embodiment, as an example, the deterioration of the battery can be further more effectively restrained.

Also, in the embodiment, as an example, the assignment part 101f assigns the vehicle 1 to each route R based on the electricity amount that can be charged at the charge spot 10 (charge device). Therefore, according to the embodiment, as an example, even when the electricity amount that can be charged at the charge spot 10 (charge device) is restricted due to the demand response and the like, the accurate service of the vehicle 1 can be provided.

Also, in the embodiment, as an example, the second calculation part 101b calculates the electricity amount that can be charged at the charge spot 10 (charge device) based on the performance value of the electricity amount of each condition. Therefore, according to the embodiment, as an example, the prediction accuracy of the electricity amount that can be charged increases. Thus, as an example, the accurate service of the vehicle 1 can be secured.

Also, in the embodiment, as an example, the third calculation part 101c calculates the deterioration degree of the battery based on the value related to the charge condition of the battery at the charge spot 10 (charge device). Therefore, according to the embodiment, as an example, the information can be obtained at the time of charging during the service of the vehicle 1, and the deterioration degree of the battery can be more efficiently obtained.

Also, in the embodiment, as an example, the update part 101e updates the electricity amount consumed during the service of each vehicle 1 along each route R by the performance value of the electricity amount of each condition. Therefore, according to the embodiment, as an example, the prediction accuracy of the consumed electricity amount increases. Thus, as an example, the accurate service of the vehicle 1 can be secured.

Also, in the embodiment, as an example, the charge control part 101h controls the charge of the vehicle 1 by the charge spot 10 (charge device) based on the electricity amount stored in the battery set by the setting part 101d. Thus, according to the embodiment, as an example, the deterioration of the battery can be more accurately or more easily restrained.

Above, the embodiment of the present invention is exemplified. However, the embodiment is an example, and it does not limit the range of the invention. The embodiment can be conducted in various forms. As far as it does not exceed the range of the content of the invention, it can be omitted, exchanged, combined, and changed. The embodiment and the transformation are included in the range and the content of the invention, and also included in the invention described in the range of the claims and the equal range.

What is claimed is:

1. A method for managing a transportation service along a plurality of routes with a plurality of vehicles, the method comprising:
allocating a vehicle to a first route;
calculating an amount of power to be used by the vehicle while the vehicle is providing transportation service along the first route;
determining a range of power to be stored in a battery of the vehicle based on at least a deterioration degree of the battery; and
reallocating the vehicle to a second route based on the calculated amount of power and the determined range of power to be stored in the battery of the vehicle.

2. The method according to claim 1, wherein the vehicle is reallocated to the second route if an amount of power that will remain in the battery throughout the transportation service is not within the determined range of power.

3. The method according to claim 1, wherein the range of power to be stored in the battery is determined by decreasing a maximum amount of power that can be stored in the battery in accordance with deterioration of the battery.

4. The method according to claim 1, wherein the range of power to be stored in the battery is determined by increasing a minimum amount of power that can be stored in the battery in accordance with deterioration of the battery.

5. The method according to claim 1, wherein the vehicle is reallocated to the second route further based on a maximum amount of power that can be stored in the battery before the transportation service is provided.

6. The method according to claim 5, wherein the maximum amount of power that can be stored in the battery before the transportation service is provided is calculated based on a maximum amount of power that has been previously stored in the battery.

7. The method according to claim 1, wherein the amount of power to be used by the vehicle while the vehicle is providing the transportation service along the first route is calculated based on an amount of power that has been previously used by the vehicle while the vehicle provided the transportation service along the first route.

8. A method for managing a transportation service along a plurality of routes with a plurality of vehicles, the method comprising:
allocating a first vehicle to a route;
calculating an amount of power to be used by the first vehicle while the first vehicle is providing transportation service along the route;
determining a range of power to be stored in a battery of the first vehicle based on at least a deterioration degree of the battery; and
allocating a second vehicle to the route in place of the first vehicle according to the calculated amount of power and the determined range of power to be stored in the battery of the first vehicle.

9. The method according to claim 8, wherein the first vehicle is replaced if an amount of power that will remain in the battery throughout the transportation service is not within the determined range of power.

10. The method according to claim 8, wherein the range of power to be stored in the battery is determined by decreasing a maximum amount of power that can be stored in the battery in accordance with deterioration of the battery.

11. The method according to claim 8, wherein the range of power to be stored in the battery is determined by increasing a minimum amount of power that can be stored in the battery in accordance with deterioration of the battery.

12. The method according to claim 8, wherein the first vehicle is replaced further based on a maximum amount of power that can be stored in the battery before the transportation service is provided.

13. The method according to claim 12, wherein the maximum amount of power that can be stored in the battery before the transportation service is provided is calculated based on a maximum amount of power that has been previously stored in the battery.

14. The method according to claim 8, wherein the amount of power to be used by the first vehicle while the first vehicle is providing the transportation service along the route is calculated based on an amount of power that has been previously used by the first vehicle while the first vehicle provided the transportation service along the route.

15. A system for managing a transportation service along a plurality of routes with a plurality of vehicles, the system comprising:
a memory unit; and
a processing unit programmed to: (i) calculate, for each vehicle providing transportation service along a route, an amount of power to be used by the vehicle while the vehicle is providing transportation service along the route and determine a range of power to be stored in a battery of the vehicle based on at least a deterioration degree of the battery; (ii) store the calculated amounts of power and the determined ranges of power in the memory unit; and (iii) reallocate the vehicles to different routes based on the calculated amounts of power and the determined ranges of power.

16. The system according to claim 15, wherein the routes include a first route and a second route, and the processing unit is programmed to reallocate a vehicle initially allocated to the first route to the second route.

17. The system according to claim 15, wherein the vehicles include a first vehicle that has been allocated to a route and a second vehicle, and the processing unit is programmed to allocate the second vehicle to the route in place of the first vehicle.

18. The system according to claim 15, wherein the processing unit is programmed to determine the range of power to be stored in the battery by decreasing a maximum amount of power that can be stored in the battery in accordance with deterioration of the battery.

19. The system according to claim 15, wherein the processing unit is programmed to determine the range of power to be stored in the battery by increasing a minimum amount of power that can be stored in the battery in accordance with deterioration of the battery.

20. The system according to claim 15, wherein the processing unit is programmed to calculate a maximum amount of power that can be stored in the battery before the transportation service is provided based on a maximum amount of power that has been previously stored in the battery.
